(19) United States
(12) Patent Application Publication
(10) Pub. No.: US 2009/0321095 A1
(43) Pub. Date: Dec. 31, 2009

(54) RHOE; THE REVERSED LEVERAGE PLOW AND HOE

(75) Inventor: DAN E. SHISLER, IV, CONWAY, AR (US)

Correspondence Address: DAN E. SHISLER IV, 1 PINE BLUFF LN, CONWAY, AR, 72034, US

(73) Assignee: DAN E. SHISLER, IV, Conway, AR (US)

(21) Appl. No.: 12/164,036

(22) Filed: Jun. 28, 2008

(51) Int. Cl. A01B 1/00

(52) U.S. Cl. 172/381

(57) ABSTRACT

The fulcrum of this gardening device is relocated enhancing leverage. Mechanical advantage is achieved by the hinged two-sectioned handle and a pulling motion by the user. By reversing the load bearing handle of the instrument, and placing it horizontal to the ground, leverage is achieved by pulling the handle section of the jointed handle rather than striking or pressing as in other tilling tools. User's foot is strapped to the plow, spade or shovel head of the tool to move the tool. The jointed staff pieces are connected with a pivot hinge or other connection, and provide a range of movement along a central pivot point. Handle is adjustable by snap lock. Connected handle segments create unified one-handled instrument instead of hinged for use as a hoe, weeding tool, or the like. Tool is an improved hand-held plow, hoe or furrowing instrument for gardening or landscaping needs.

### BACKGROUND OF THE INVENTION

Fixed handled digging instruments have long been known and widely used for soil work. Shovels, hoes and plowing instruments have existed since early agricultural periods. Most current instruments place the work fulcrum either disproportionately high on the tool, or in another position which creates inefficiencies in the work attempted. This invention works with a hinged, pulling action to allow greater workload of the tool without increased work from the user. The handled section of the tool works in a pulling motion toward the user as in pulling a lever. The second section, having a plow, spade or shovel type head, works by being pushed into the ground by foot. Many tillers, plows and other instruments overcome this deficiency with gasoline power. This invention, turns the handle away from the user and horizontal to the ground to harness the leverage lost in other furrowing instruments.

The present tool as configured is very suitable for less stress on the back than traditional manual garden instruments. This invention can be used as an inexpensive instrument as compared to engine based tools that do the same work and can be used to loosen soil from a standing position.

Traditional manual tilling methods use an inefficient action of swinging a hoe or similar tool to toward the ground trying to penetrate the ground. This invention enhances the garden tool by utilizing the strength of the users foot to penetrate the ground as such in a shovel and the ease of a lever action to pull the soil thus tilling with little physical exertion.

Many soil-turning machines exist that use engine technology but are either not economical or too cumbersome to use in small garden or landscape areas. This invention can be more easily affordable and used by more due to its ease of manual labor required. It is more desirable due to its small size being easily stored with other household tools such as a shovel, rake, or hoe. This invention offers a reasonable alternative to large, expensive engine tillers. This invention offers an entire package in one that can handle turning the soil, extracting weeds, and aerating the soil. Other traditional tools only tackle one task. Hoes focus on breaking up the soil, leaving the roots of weeds to continue to stay and grow in the ground. Traditional weeding machines do nothing to break up the surrounding soil. Traditional aerators do not truly turn the soil from bottom to top; they only break up the soil. This is an innovative way of thinking about utilizing the physical effort involved with the moving and tilling of soil.

### SUMMARY OF THE INVENTION

The stated invention provides an easier way to perform traditional gardening duties including turning and tilling the soil. The invention is a simple design that changes the fulcrum of the digging device for more leverage by the user. This simple leverage change is more efficient for gardening activities than previous hoes, plows, or manual tiller designs.

The device consists of a jointed staff, the top extension having a handle and the bottom portion having a digging device. The two staff portions are hinged providing the central pivot point. In use, the hinge is one of main advances unique to this tool from traditional gardening tools. The hinge provides the reversed fulcrum for a pulling action that in turn pulls the bottom half of the tool for job performance.

The bottom portion with the digging device consists of one part shovel, hoe, or the like with a footrest attached for penetration of the soil. The footrest also consists of an adjustable strap for more ease to the user. The tilling device outlined overcomes the shortcomings of previous like tools with regards to penetration of soil and physical exertion necessary by the user. The traditional inadequacies of previous tools are in their use by trying to penetrate the ground by swinging or striking with the upper body is overcome by the hinged shovel like portion of the tool. The power is provided manually through the lower body to penetrate the ground. The plow, shovel, or tilling device is pushed into the soil with the user's foot, manually forcing the instrument into the soil. Then the user is able to pull the handle, which in turn, pulls the plow part of the tool, loosening and turning the soil. It is a further advantage of the tool to use a leveraged pulling motion to extract the digging device from the ground by the hinged staff rather than trying to move soil with the shoulders and upper body of the user. The reversed leverage action of the tool allows the user to reap more results without requiring more physical exertion.

It is the objective of this invention to provide an easy, manual gardening tool that will loosen and till the soil without extreme physical exertion or with engine propelled machines. The invention provides one tool for home gardening or landscaping combining several traditional tools into one.

It is also an objective of this invention to perform gardening or landscaping duties such as aerating the soil and weeding a plot of land easily and efficiently. This invention requires less physical hardship such as repetitive stooping, swinging, or pushing by its unique design.

Additional objects of this invention will be outlined in the following detailed description and claims.

### BRIEF DESCRIPTION OF DRAWINGS

For a more in depth understanding of the present invention, refer to the following detailed description. Referencing the accompanying drawings labeled as follows:

FIG. 1 is a respective view in which the tool is in an upright position at a 90-degree angle at the hinge showing the entire tool, i.e. handle, top section of rod, bottom section of rod, foot rest with strap, and digging device.

1A shows a close up of the handle.

1B shows an enlargement of the hinge embodiment.

1C shows an enlargement of the digging device.

FIG. 2A shows the starting position of tool when user will begin operation.

FIG. 2B, is of the same viewing angle of tool and user when application to the hoe digging device has begun to enter the ground.

FIG. 2C is the same viewing angle of tool and user when application of pulling the handle forces the action of the digging device to exit the ground.

FIG. 2D is the same viewing angle of tool and user when final application of pulling action releases the digging device from the ground, thus turning, tilling, and aerating the soil.

FIG. 2E is the same viewing angle of tool and user when starting position is repeated for continued use in a specific plot of land.

FIG. 3 shows the alternate use by this invention in which the hinged part of the rod handle is locked into position for traditional use as a hoe.

FIG. 4 shows an enlarged view of the digging device, foot pedestal and strap.

This illustration also shows an addition to the invention allowing the user to adjust the length of the bottom portion of the rod handle for optimal leverage of the user

### DETAILED DESCRIPTION OF THE INVENTION

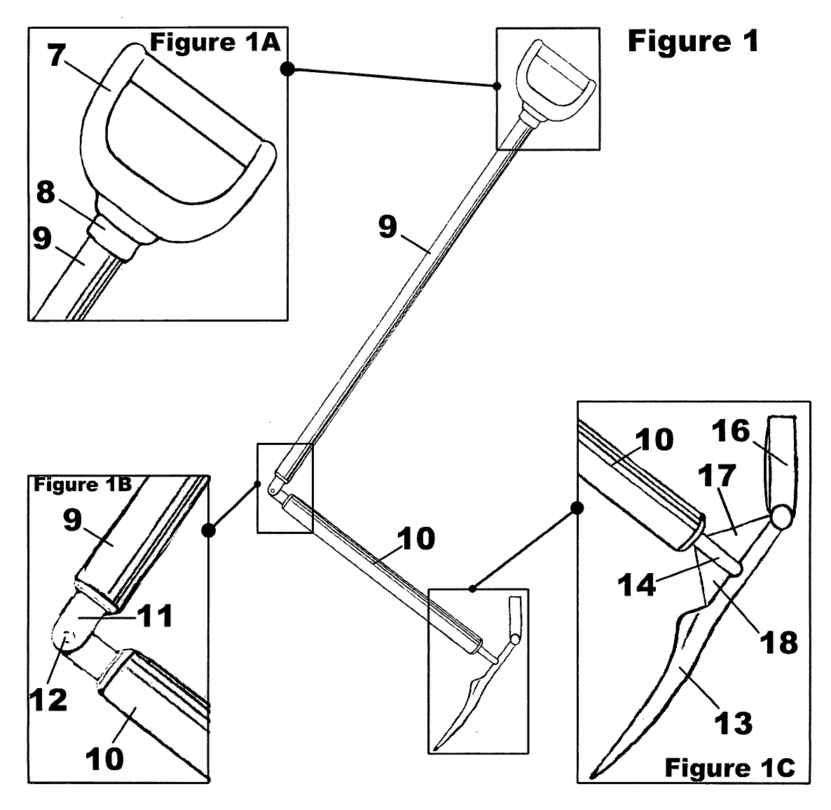

FIG. 1. This illustration shows the invention in full view with three enlargements included as 1A, 1B, and 1C. The full view shows the D-shaped handle in FIG. 1A with a handle made from metal, plastic, wood or similar material (7). The handle is connected to the shaft (9) by a male to female connection (8). The top section of the tubular shaft (9) made of metal, plastic, wood or a similar material is connected to the bottom section (10) by a hinged apparatus (11). The lower section of the rod-shaft (10) is composed of the same material as the top section (9). FIG. 1B shows an enlarged view of the hinged connection which is the centerpiece of the invention. This hinge allows the reversal of torque and connects the top-handle shaft (9) to the bottom-handle shaft (10) by a traditional hinge (11) and pin (12) connection. FIG. 1C depicts an enlarged view of the tool head. The head consists of a shovel like hoe (13) consisting of metal material connected to the bottom-handled shaft (10) by a metal rod(14) with a brace (17,18) for added support and strength. The footrest (15) acts as the pressure point for the digging action and is made of like materials to the shovelhead. The strap (16) attached to the footrest is an added feature for support and assist in foot placement and steadiness, which will pivot to accommodate the user's foot action on the tool.

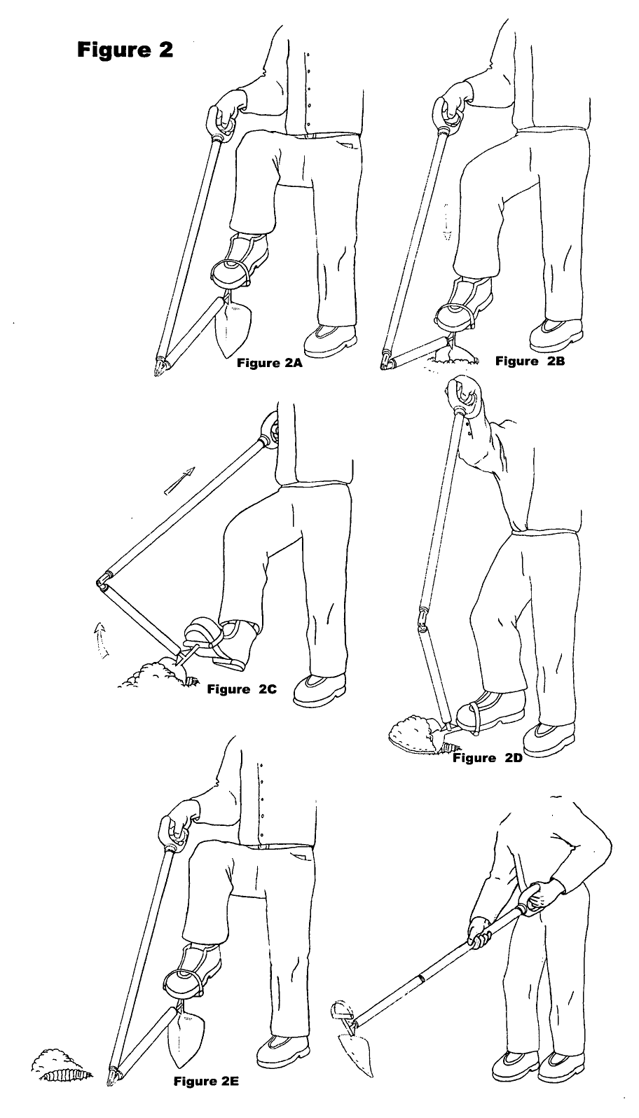

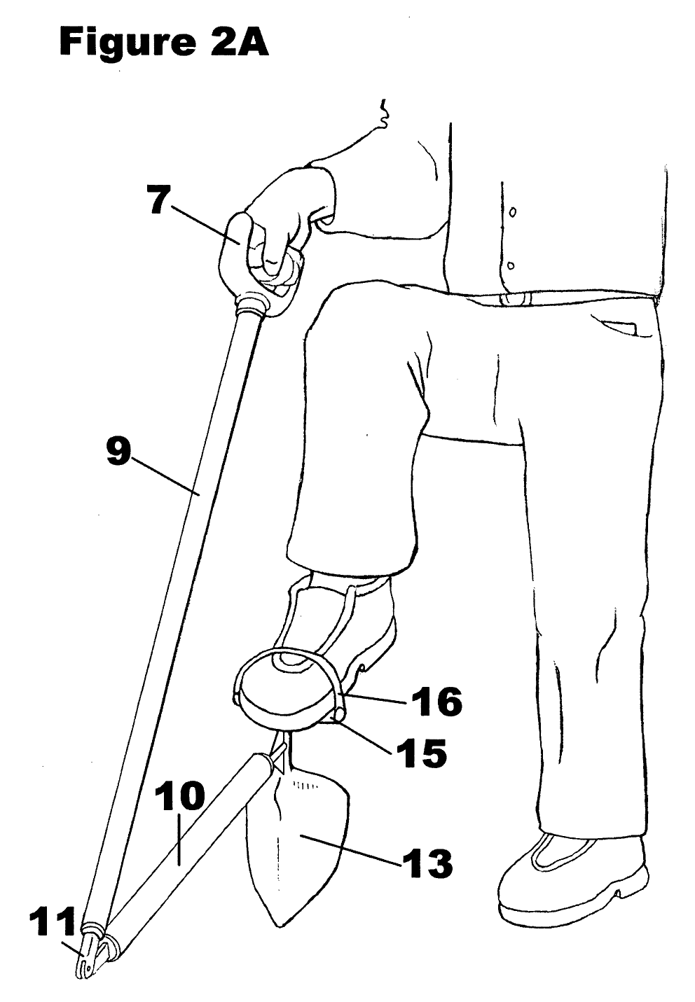

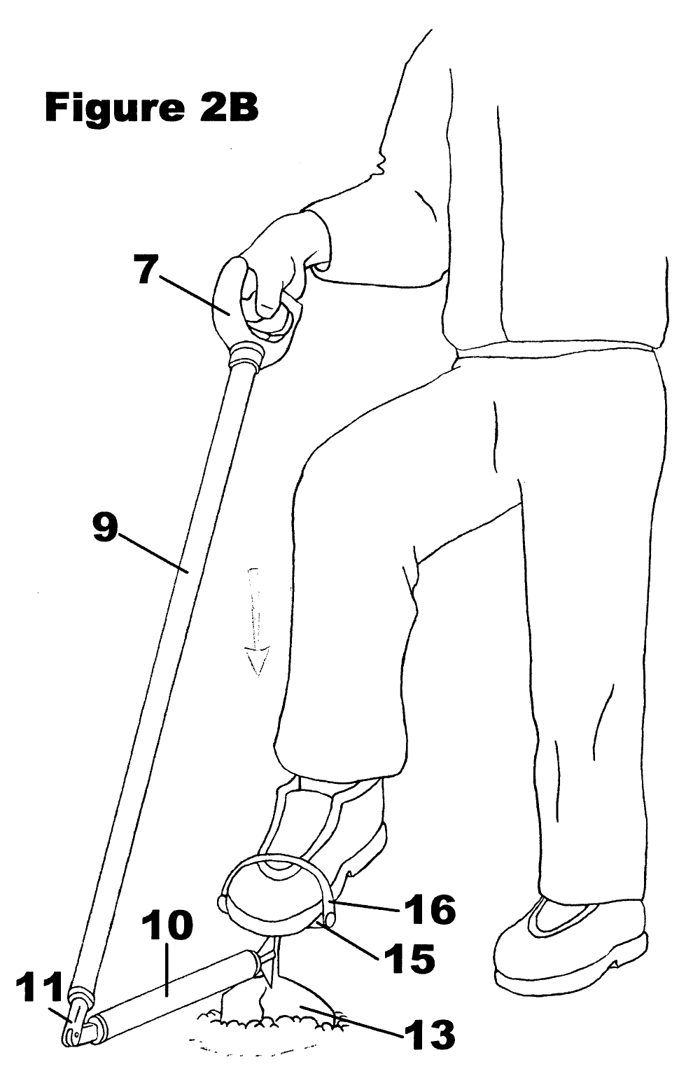

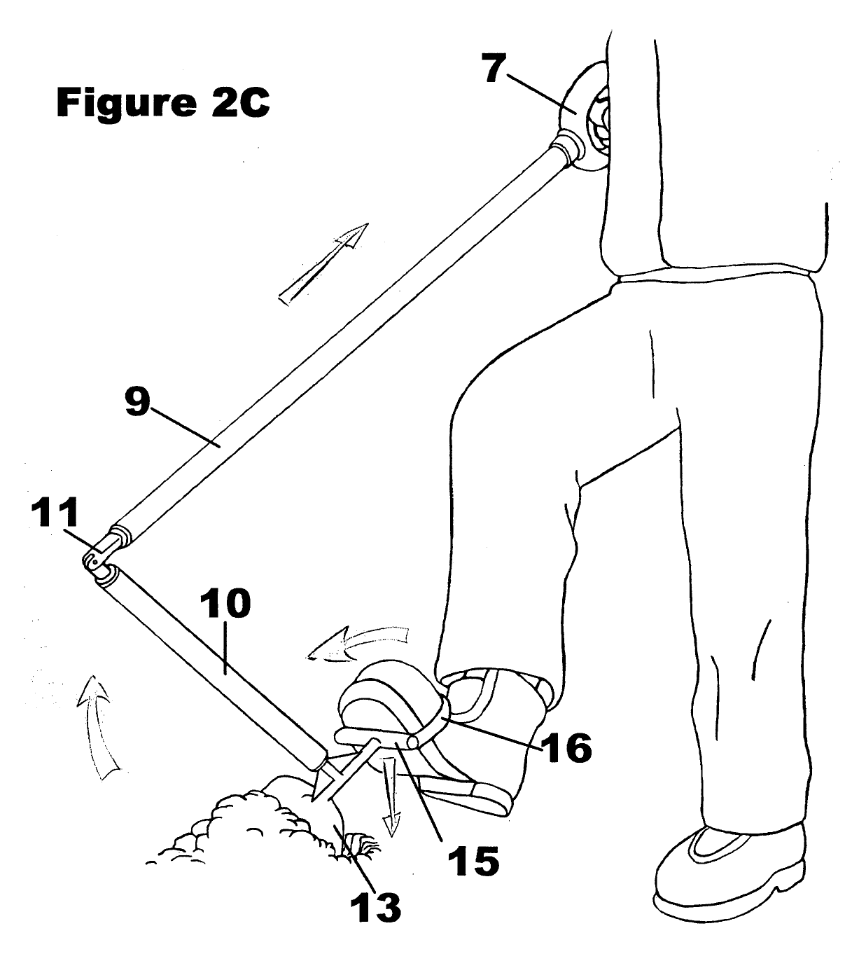

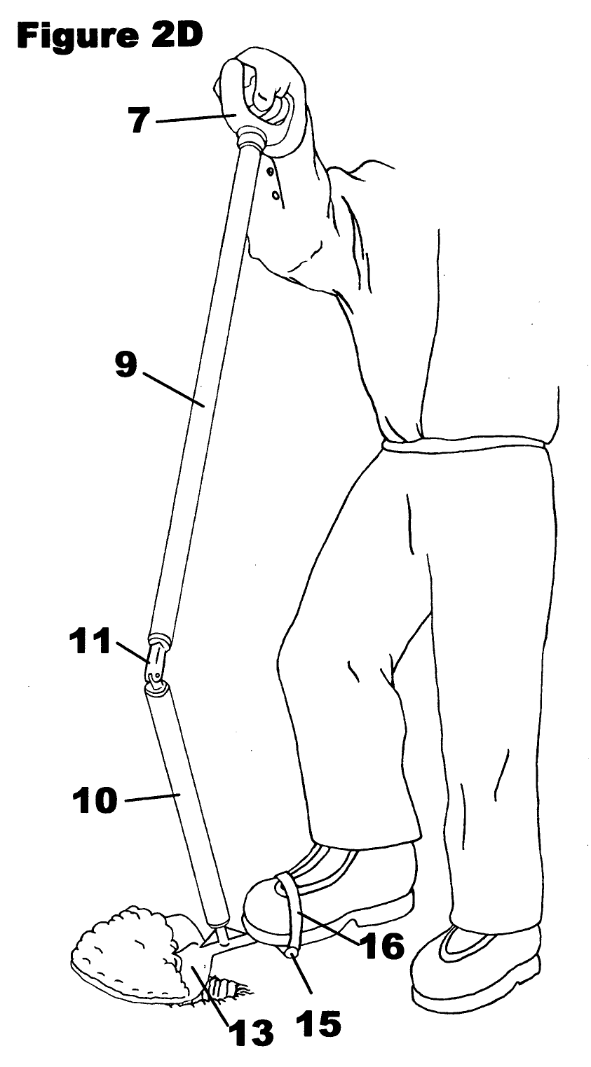

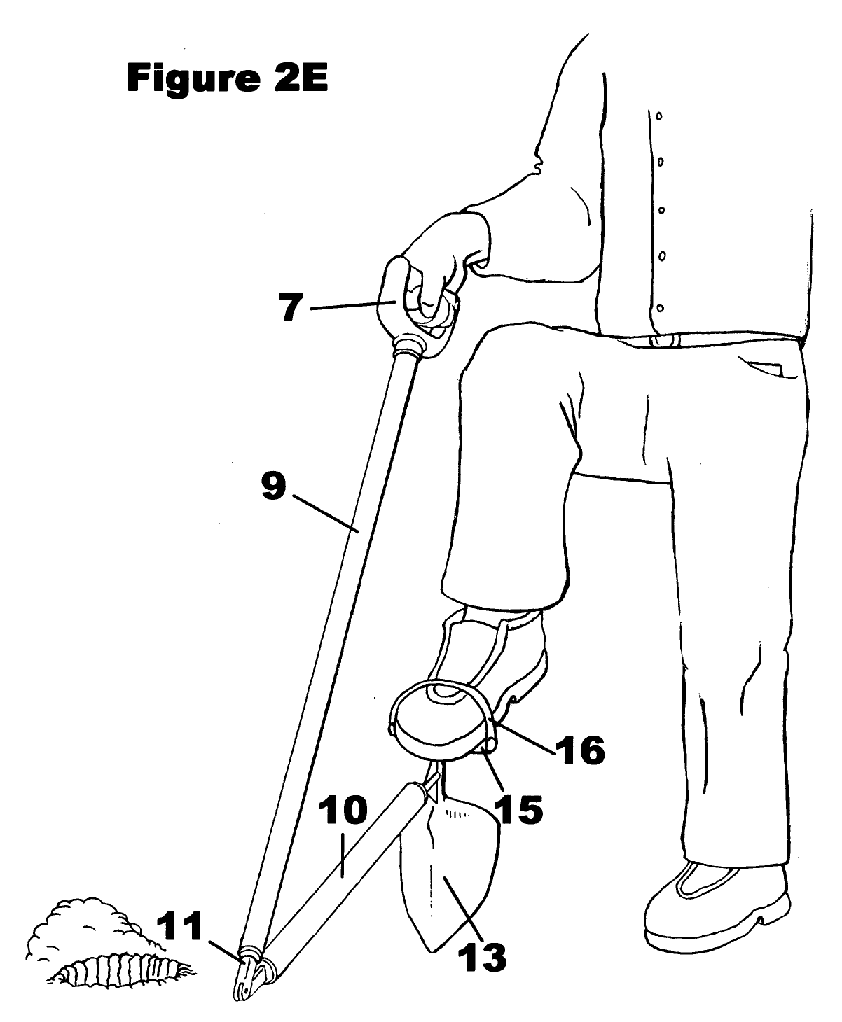

FIG. 2. 2A illustrates the tool in action to begin digging, aerating, or weeding the area. The foot will push the shovel-head (13) into the ground to begin the reversal hoe process. The top-handle shaft (9) stands almost parallel to the user while the bottom-handle shaft (10) is approximately parallel to the ground using the hinge connector (11). FIG. 2B depicts the second action of the tool when the shovelhead has been compressed into the soil. The top-handle and bottom handle shafts have not been yet been affected by the action of the shovel-head going into the soil. FIG. 2C indicates the digging action using the reversal torque process that is unique for this tool. The user pulls the handle (7) towards the body causing the top-handle shaft (9) to work through the hinge (11) to pull the bottom-handle shaft (10) which in turn causes the shovel-head (13) to pull out of the soil. The user can also get additional torque by pushing the shovelhead by foot with the footrest (15). The process of pulling on the handle (7) and/or pushing on the footrest (15) is the unique importance of this invention. The illustration in 2D shows the soil being dug by the shovelhead (13) that can be used to hoe a garden, aerate the soil, or dig out individual weeds. The top-handle shaft (9) and bottom-handle shaft (10) are both upright and approximately parallel to the user. 2E demonstrates the tool after first use ready to begin the process again.

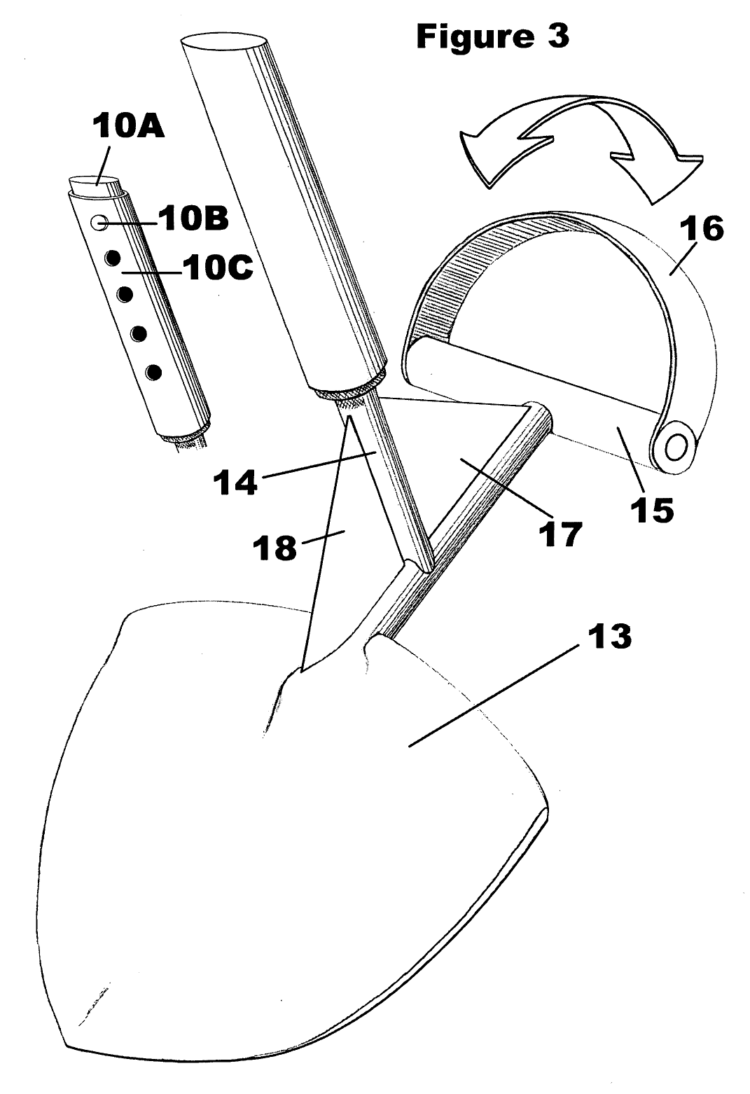

FIG. 3. The depiction shows the shovelhead with an enlarged illustration. The footrest strap (16) action is indicated to show the versatility of the strap to guarantee the comfort of the user, making sure that the user's foot is secure on the footrest (15). The figure in 3a shows an alternative build option for the bottom-handle shaft (10) for additional ease to the user. The locking pin action on the optional handle allows the user to change the length of the shaft to adjust the torque of the pulling action by the user. This is an easy addition that can make a difference to the user comfort of the tool.

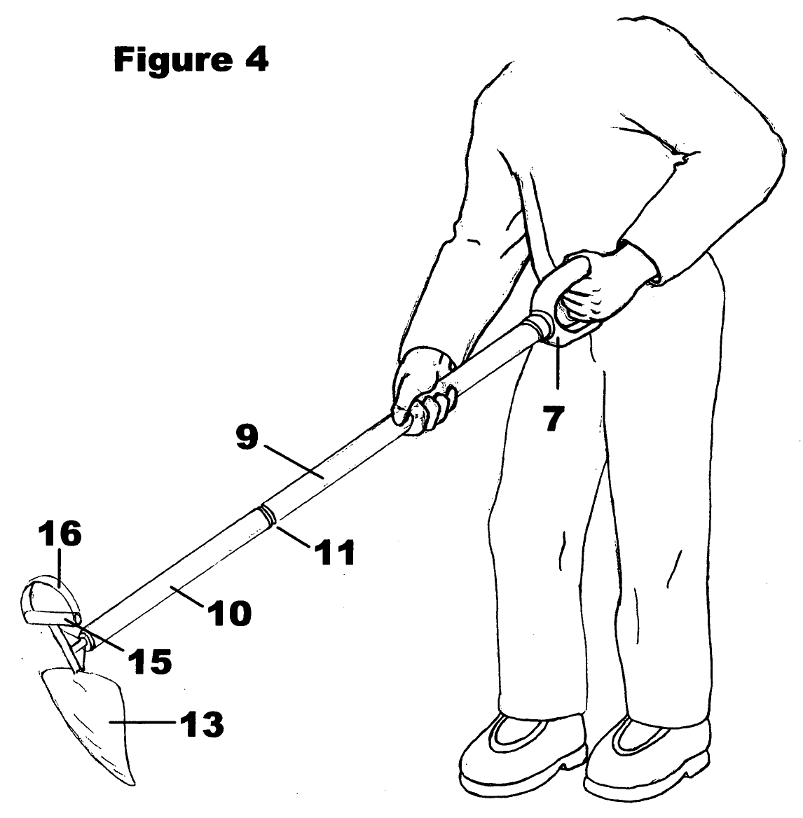

FIG. 4. This illustration demonstrates the alternative use for the tool as a traditional hoe by locking the top-handle shaft (9) to the bottom-handle shaft (10) by the connector hinge (11). This alternative use for the tool allows for the dirt that has been dug up and aerated to be moved around as needed with ease by the user.

1. A hand and foot powered tool used for digging, breaking up, aerating, tilling or turning a plot of soil manually by use of:
A. A rod member having an upper and lower portion connected by a hinge,
B. The top portion of the rod member having a handle,
C. The bottom portion of the rod member having an attached hoedigging device with a footrest the propelling motion into the ground.
D. Hoe digging device details
E. Foot rest and strap detail

2. The leverage point for the handle members increase torque at the dig point of impact with the soil. The leverage increases power without strain on the user.
A. Relocation of power origination from the traditional upper body, with other like manual tools, to the lower body with impact of the soil. The pulling action of the handle to raise the digging device from the soil is beneficial for the user by adding power through the action built into the tool.

3. Manual use of the tool gives the user more control of cost and ease of use than traditional engine powered tools.
